(19) United States
(12) Patent Application Publication
(10) Pub. No.: US 2002/0042844 A1
(43) Pub. Date: Apr. 11, 2002

(54) Synchronized sampling on a multiprocessor backplane via a broadcast timestamp

(76) Inventor: Giovanni Chiazzese, Pierrefonds (CA)

Correspondence Address: F. Drexel Feeling, Esq., Jones, Day, Reavis & Pogue, North Piont, 901 Lakeside Avenue, Cleveland, OH, 44114, US

(21) Appl. No.: 09/920,423

(22) Filed: Aug. 1, 2001

Related U.S. Application Data
(60) Provisional application No. 60/223,082, filed on Aug. 4, 2000.

(51) Int. Cl. G06F 15/16

(52) U.S. Cl. 709/248; 709/251

(57) ABSTRACT

A multiprocessor system is provided that comprises a plurality of processor units coupled together via a backplane and a timestamp distribution system. The timestamp distribution system provides a first time signal to the plurality of processor units over the backplane. The timestamp distribution system comprises a first timestamp distributor for generating the first time signal and a first timestamp communication bus on the backplane for transporting the first time signal from the timestamp distributor to the plurality of processor units. The first time signal comprises a first time data word that is transmitted at a periodic rate wherein the first time data word does not change each time the first time signal is transmitted.

This application claims the benefit under 35 U.S.C. §119(e) to copending U.S. Provisional Patent Application No. 60/223,082 entitled “Synchronized Sampling On A Multiprocessor Backplane Via A Broadcast Timestamp” and filed on Aug. 4, 2000. This application also incorporates copending U.S. Provisional Patent Application No. 60/223,082 by reference as if fully rewritten here.

### BACKGROUND

1. Technical Field

The claimed invention relates to the field of multiprocessor computer architecture. In particular, the claimed invention relates to time synchronization within a multiprocessor computer architecture.

2. Description of the Related Art

The synchronization of multiprocessor operation in a multiprocessor environment provides many advantages for a system. If operations can be synchronized, tasks can be delegated to different processors resulting in higher speed and system capabilities.

### SUMMARY

To improves upon the current state of the art, provided is a multiprocessor system that has a broadcast timestamp mechanism for synchronizing the operation of a plurality of processors within the multiprocessor system. The broadcast timestamp allows a plurality of independently operating processor domains to perform some functions on a coordinated basis.

In accordance with one aspect of the claimed invention, a multiprocessor system is provided that comprises a plurality of processor units coupled together via a backplane and a timestamp distribution system. The timestamp distribution system provides a first time signal to the plurality of processor units over the backplane. The timestamp distribution system comprises a first timestamp distributor for generating the first time signal and a first timestamp communication bus on the backplane for transporting the first time signal from the timestamp distributor to the plurality of processor units. The first time signal comprises a first time data word that is transmitted at a periodic rate wherein the first time data word does not change each time the first time signal is transmitted.

In accordance with another aspect of the claimed invention, a method is provided for performing synchronized operations in a multiprocessor system. The method comprises the steps of (a) providing a timestamp distributor system comprising a first timestamp distributor for generating a first time signal and a first timestamp communication bus on a backplane for transporting the first time signal from the timestamp distributor to the plurality of processor units in the multiprocessor system; (b) generating the first time signal with the first timestamp generator, wherein the first time signal comprises a first data frame having a first time data word; (c) transmitting the first data frame at a periodic rate; and (d) signaling a plurality of the processor units to perform some action by changing the first time data word, wherein the first time data word is not changed each time the first data frame is transmitted.

### BRIEF DESCRIPTION OF DRAWINGS

The claimed invention will become more apparent from the following description when read in conjunction with the accompanying drawings wherein:

FIG. 1 is a system block diagram of a multiprocessor system that incorporates a timestamp generator;

FIG. 2 is a front view of an exemplary backplane base multiprocessor system in which the claimed invention is useful;

FIG. 3 is a schematic view of an exemplary backplane based multiprocessor system;

FIG. 4 is a block diagram of an optical ring network in which the claimed invention is useful;

FIG. 5 is a block diagram of a multiprocessor system that incorporates dual timestamp generators;

FIG. 6 is a timing diagram for signals on the timestamp bus;

FIG. 7 is a diagram showing an exemplary timestamp bus data format;

FIG. 8 is a block diagram of an exemplary multiprocessor system in which the processor cards have direct links to the timestamp distributors;

FIG. 9 is a block diagram of an exemplary timestamp generator;

FIG. 10 is a block diagram of an exemplary timestamp bus data insertion interface unit;

FIG. 11 is a block diagram of an exemplary timestamp bus monitoring interface unit; and

FIG. 12 is a block diagram of an alternative embodiment of a multiprocessor system that incorporates the claimed invention.

### DETAILED DESCRIPTION OF EXAMPLES OF THE CLAIMED INVENTION

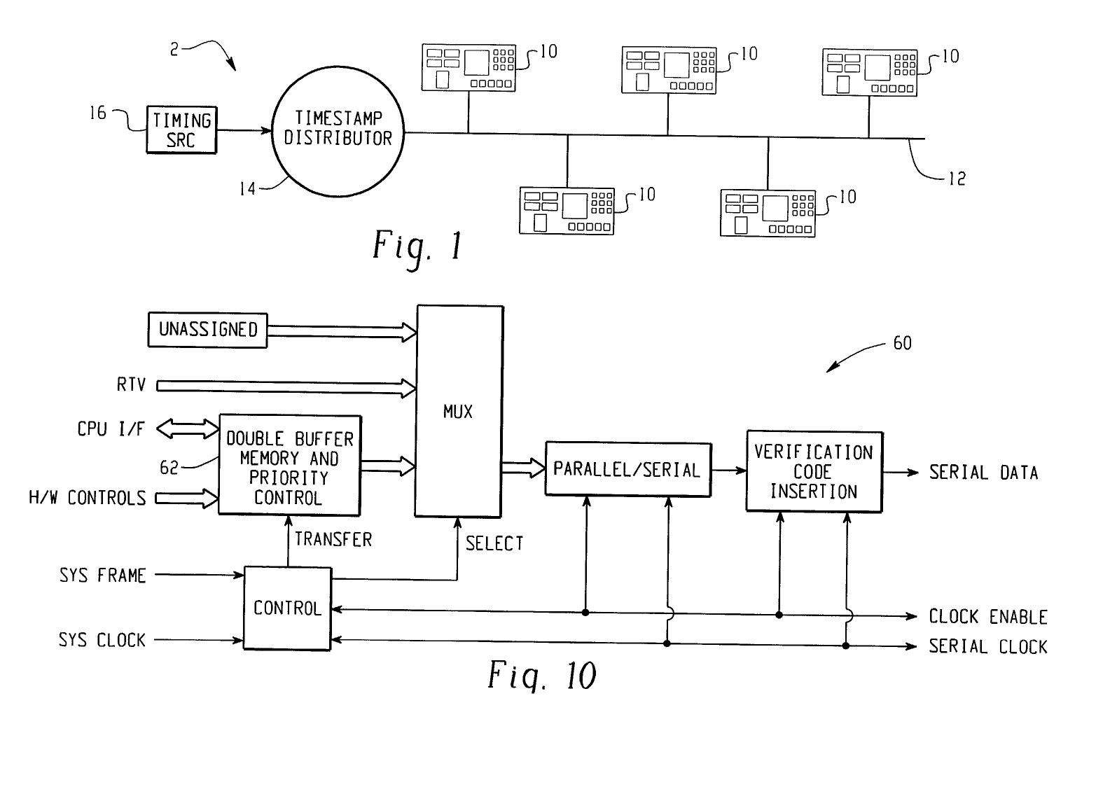

With reference to the figures, FIG. 1 sets forth a block diagram of an exemplary multiprocessing system 2 that incorporates the claimed invention. The multiprocessor system 2 includes a plurality of processors 10 that are capable of performing many functions, such as data collection, on a synchronous basis. In the exemplary system 2, the plurality of processors 10 are coupled together via a communication bus 12 and are also coupled to a timestamp distributor 14. The timestamp distributor 14 provides a timestamp sync signal over the bus 12 to the processors 10 to provide the processors 10 with a means for synchronizing their internal clocks. Using the timestamp sync signal, the processors 10 are capable of synchronizing their functions within the system. The system 2 also includes a timing source 16 that provides a clock signal for driving the timestamp distributor 14. The timing source 16 could alternatively be a clock signal that is exterior to system 2 or, preferably, be a timing source that is located within the system 2 such as a system clock.

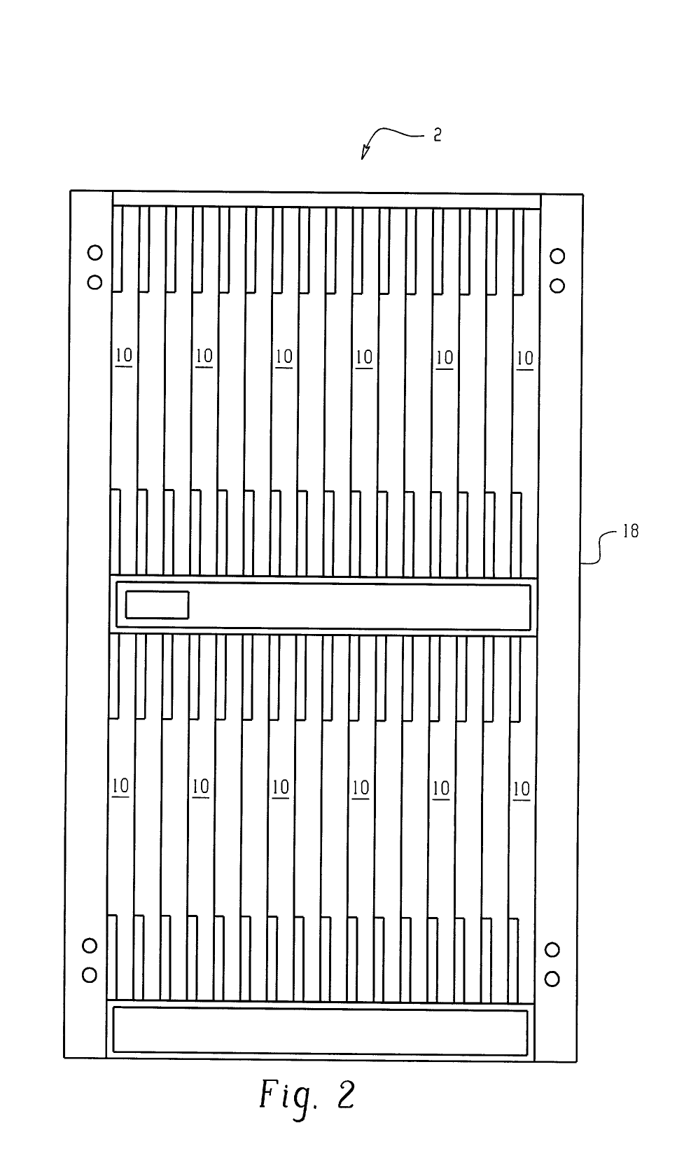

As shown in FIG. 2, the preferred multiprocessing system 2 is a backplane based system comprising a plurality of processors modules 10 that are mounted in a shelf 18. As shown in FIG. 3, the shelf 18 contains a backplane 20 which provides a physical media for allowing the processors 10 to communicate with each other. Each processor 10 includes a connector 22 for providing electrical communication pathways between the backplane 20 and components on the processors 10.

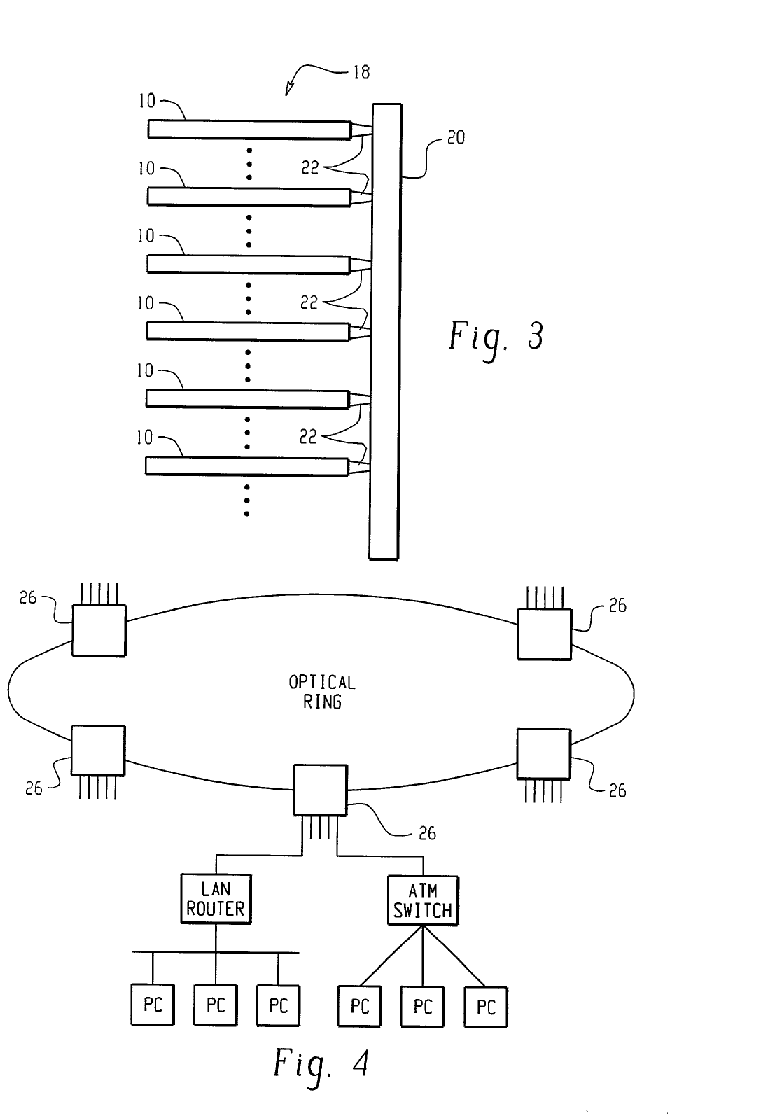

As shown in FIG. 4, the exemplary multiprocessor system 2 is a multiple services carrier node 26 that can be used in networks carrying frame-, packet-, and cell-based traffic. The processor modules in this node 26 are either traffic carrying modules, i.e., modules that carry IP or ATM traffic to or from the node, or cross-connect modules, i.e., modules that pass IP or ATM traffic from one traffic carrying module to another traffic carrying module or traffic processing modules that manipulate the traffic in some way.

The claimed invention provides a system for synchronizing a real time clock in all processors 10 in a multiprocessor system 2. The system also provides a mechanism whereby processor data collection functions can be synchronized using a distributed timestamp sync signal. In the preferred embodiment, the timestamp generator 14 transmits a periodic timestamp sync signal to the processors 10 wherein the timestamp sync signal includes a time value signal. Preferably, the timestamp sync signal is transmitted every 125 μs (8 Khz) and the time value is not updated at each transmission but, instead, preferably is updated once per second. In response to sensing a change in the time value signal, the processors 10 are programmed to perform their data collection functions. In the preferred system, when the change is sensed, the processors 10 freeze their monitoring registers in their current state allowing a background collection function to acquire, process and store data reflecting the state of the system at a precise moment in time. Because the data sample acquired can be identified by its unique time value, data collected across various processors can be correlated. A net effect of this process is that much processing overhead, and storage of data can be delegated locally to any processor.

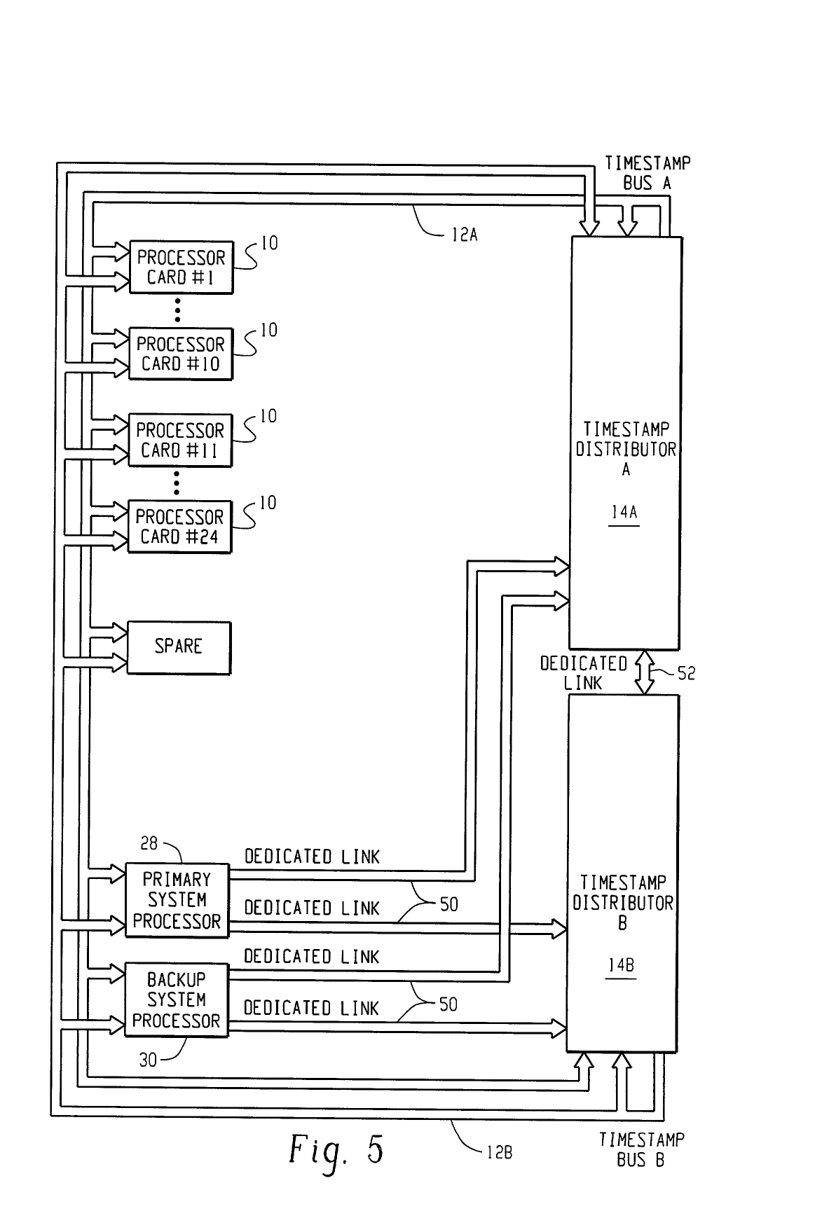

As shown in FIG. 5, the preferred multiprocessor system includes redundant timestamp distributors: Timestamp distributor A 14A and Timestamp distributor B 14B. The preferred multiprocessor system also includes redundant timestamp busses: Timestamp bus A 12A and Timestamp bus B 12B. In addition, the preferred multiprocessor system of FIG. 5 includes twenty-four general processor cards 10, as well as two special processor cards: a primary system processor 28 and a backup system processor 30. Timestamp distributor A 14A is operable to supply a timestamp sync signal to the processor cards 10, the primary system processor 28, the backup system processor 30, timestamp distributor A 14A, and backup timestamp distributor A 14B via timestamp bus A 12A. Timestamp distributor B 14B is operable to supply a timestamp sync signal to the processor cards 10, the primary system processor 28, the backup system processor 30, timestamp distributor A 14A, and backup timestamp distributor A 14B via timestamp bus B 12B. In the preferred multiprocessor system, Timestamp bus A 12A and Timestamp bus B 12B are each physically located on the backplane 20. The preferred multiprocessor system 12 also preferably includes a system clock which functions as the timing source 16 for the timestamp generators 14 of the claimed invention.

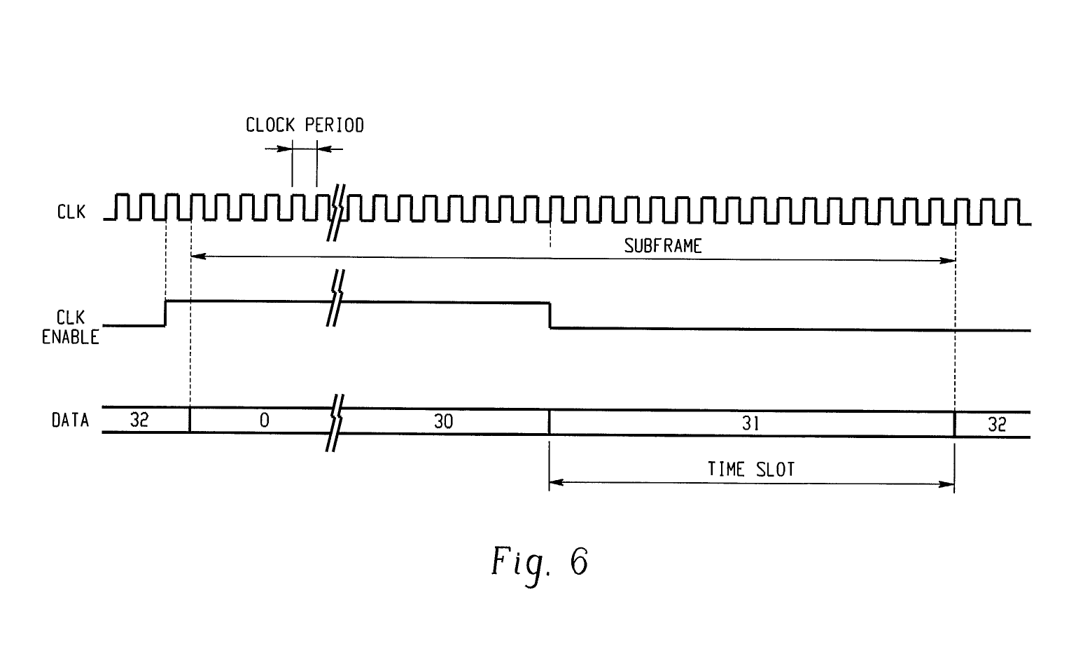

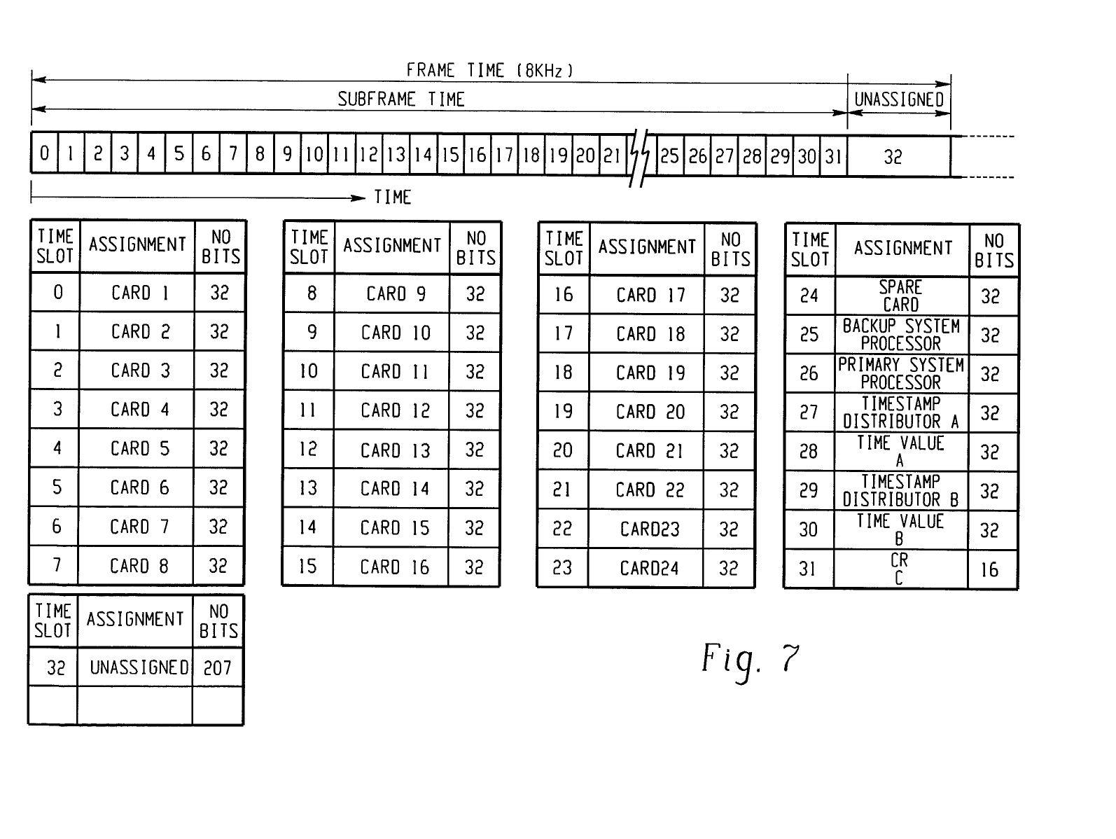

The preferred timestamp distributors 14 communicates with the processor cards 10, the primary system processor 28 and the backup system processor 30 over the timestamp bus 14 by generating a clock signal, a clock enable signal, and frames of time-slotted data, as shown in FIG. 6. In the preferred system 2, the timestamp distributors 14 generate 33 time-slot (slots 0-32) frames of 1215 bits/frame data as shown in FIG. 7. Time slots 0-30 are 32 bit time slots, slot 31 is a 16 bit slot and slot 32 is a 207 bit unassigned time slot. In the embodiment shown, the time value signal on bus 12A for timestamp distributor A 14A resides in time slot 28, the time value signal for timestamp distributor B 14B resides in time slot 30, and an error correction code CRC resides in time slot 31. On bus 12B, the time value signal for timestamp distributor A 14A resides in time slot 30 and the time value signal for timestamp distributor B 14B resides in time slot 28.

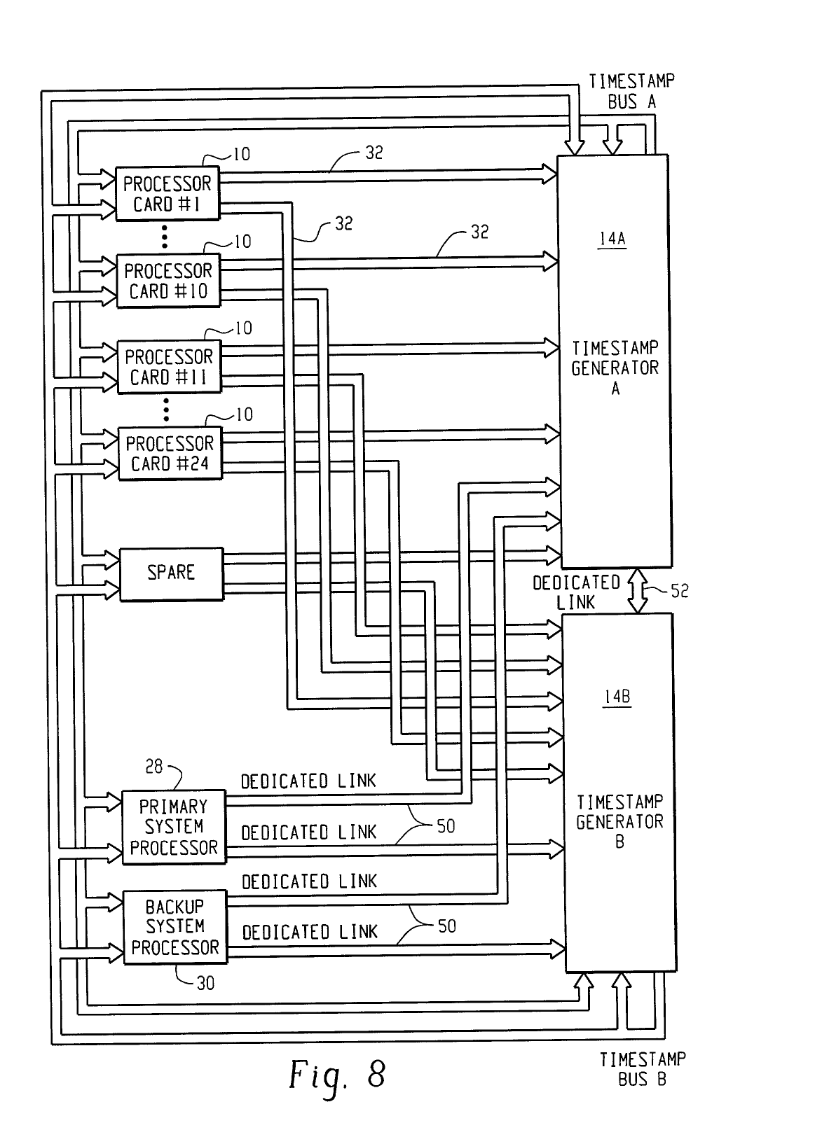

As shown in FIG. 8, the processors 10 optionally could include a communication link 32 to each of the timestamp distributors 14. These links 32 preferably are used by the processors 10 to communicate status or other information regarding the processors 10 to the timestamp distributors 14. These links 32 preferably are located on the backplane 20 and comprise a plurality of communication paths. The timestamp distributors 14 preferably communicates the received status information to the processors over the timestamp buses 12. As shown in FIG. 7, a time slot preferably has been allotted for the timestamp distributors 14 to communicate information regarding each processor 10, each timestamp generator 14A and 14B, and the primary and backup system processors 28 and 30.

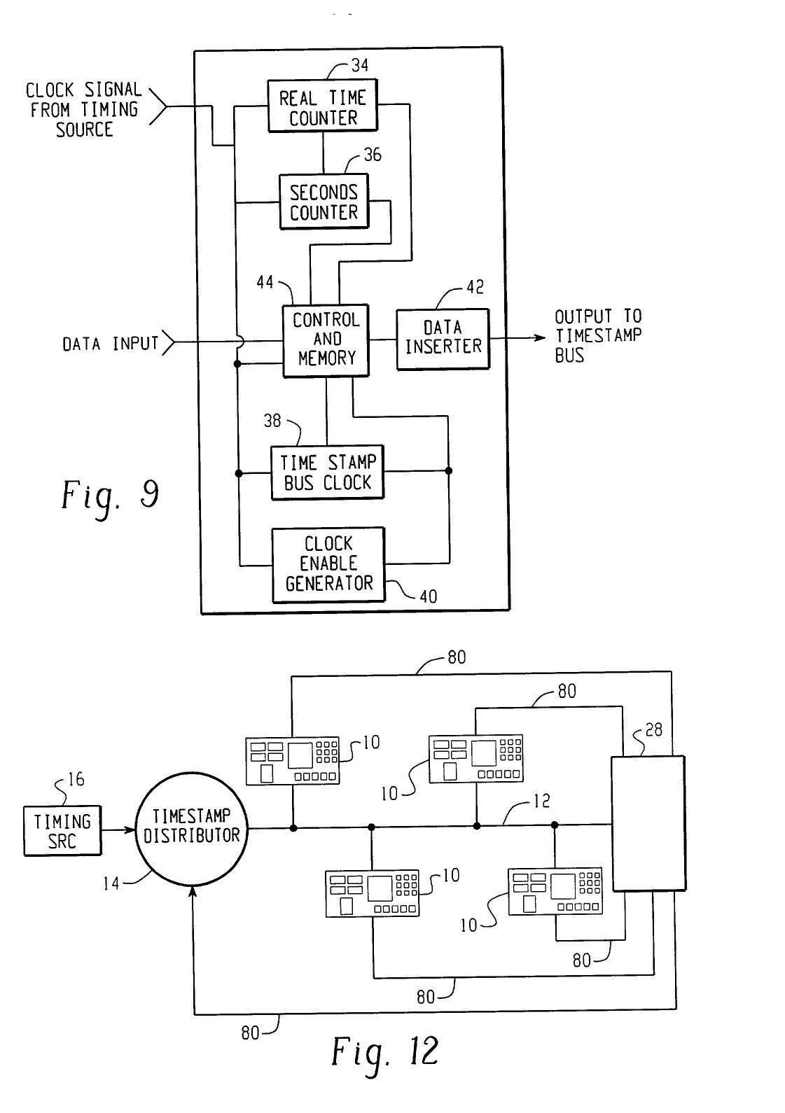

As shown in FIG. 9, the preferred timestamp generators 14 include a real time counter 34 for generating a real time value (RTV) as the time value signal. This RTV is communicated once per frame and updated once per second based on the operation of a seconds counter 36. Both the real time counter 34 and the seconds counter 36 are driven by a clock signal from timing source 16.

The preferred timestamp generators 14 also include a serial clock generator 38, which preferably is a counter, and a clock enable generator 40. The serial clock generator 38 preferably comprises a counter that divides down the clock signal from the timing source 16 to provide a serial clock for the serial data. Alternatively, the serial clock generator 38 could comprise other devices such as a phase locked loop. The clock enable generator 40 generates a clock enable signal which preferably changes high one clock cycle before the MSB of the first time slot (time slot 0) and changes to low before the MSB of the CRC word. The clock enable and data signals change on the rising edge of the serial clock. The data is transmitted MSB first. The preferred timestamp generators 14 also include a data insertion system 42. The data insertion system 42 inserts frames of data onto the bus 12. In addition, the preferred timestamp generators 14 include control and memory 44 for controlling the operation of the timestamp generators 14.

The operation of the timestamp generators 14 will be described next. In the preferred system 2 the Real Time Value to be used by all the processors is set by the primary system processor 28 at power up. The primary system processor 28 sends this Real Time Value to timestamp distributor A 14A using dedicated link 50. When timestamp distributor A 14A receives the Real Time Value, it unlocks the loading of the hardware real time counter 34 and unlocks the reset of the seconds counter 36 (based on the 8 kHz frame pulses). Timestamp distributor A 14A updates its hardware real time counter 34 and resets the hardware seconds counter 36. The loading of the real time counter 34 with the RTV and the resetting of the seconds counter 36 forces a lock condition. Timestamp distributor A 14A becomes the real time master.

The timestamp distributor 14A begins to transmit data over the timestamp bus A at a 8 KHz frame rate. The seconds counter 36 provides a trigger each second that causes the timestamp distributor 14A to insert a new RTV from the hardware real time counter 34 into the time value slot in the data frame. In the other data frames, time value remains the same as the last updated Real Time Value. The primary system processor 28 should not have to send a Real Time Value to the timestamp distributor 14A after the initialization unless the timestamp distributor 14A malfunctions or a user forces a time update.

The primary system processor 28 also sends the Real Time Value to timestamp distributor B 14B using a dedicated link 50. The Real Time Value is ignored since timestamp distributor B 14B is the slave timestamp distributor, but the message serves the purpose of unlocking the loading of the hardware Real Time Counter 34 and unlocking the reset of the Seconds Counter 36. Timestamp distributor B 14B then waits for the first change of the Real Time Value on the Timestamp Bus A.

When the first Real Time Value change on timestamp bus B 12B is detected, the slave timestamp distributor B 14B updates its hardware real time counter 34 using the Real Time Value in the time value data slot on bus A, and resets the hardware seconds counter 36 (based on the 8 kHz frame pulse). Loading of the real time counter 34 and the resetting of the seconds counter 36 forces the lock condition. Subsequent changes of the Real Time Value of timestamp distributor A 14A have no effect on the slave's real time counter 34 and seconds counter 36.

The seconds counter 36 provides a trigger each second that causes the timestamp distributor B 14B to insert a new RTV from the hardware real time counter 34 into the time value slot in the data frame on the timestamp bus B 12B.

A dedicated link 52 is provided between timestamp generators A and B to allow them to communicate. Timestamp generator B can become the master timestamp generator, for example, if timestamp generator A malfunctions.

The real time status of any processor 10, the primary system processor 28, the backup system processor 30, and the 2 timestamp distributors 14 is invalid during the power up sequence and the application software initialization. It remains invalid afterwards until the first Real Time interrupt triggered by the first Real Time Value change of timestamp distributor A 14A on the timestamp bus B 12B. Each processor 10 preferably initiates this data collection function through the use of a real time interrupt. When the first Real Time interrupt is executed by the local CPU of a card, the Real Time information is updated with the value received in the Timestamp bus and the Real Time Status becomes valid. Subsequently the execution of each Real Time interrupt will update the Real Time information of the card and the Real Time Status remains valid.

Real time synchronization is ensured, in part, through the one-time update of the hardware real time counter of the slave timestamp distributor card using the master timestamp distributor's Real Time Value.

At the same time, the slave timestamp distributor's seconds counter is reset, with the transmission time of the Real Time Value through the timestamp bus A taken into account.

The seconds counter of both Timestamp distributor cards are reset at a point where the trigger occurs well before the Real Time Value must be sent on the timestamp bus, such as at the center of a data frame. This ensures that if there is a slight variation between each timestamp distributor due to clock wander, the Real Time Value sent by each timestamp distributor will be identical.

The timestamp bus consists of 3 signals: Clock, Clock enable and Data. Each of these signals is supplied by the timestamp distributor. The clock frequency preferably is an integer divider of the 77.76 MHz system clock.

Shown in FIG. 10 is an exemplary model of the timestamp bus insertion mechanism 42. The insertion mechanism 42 uses double buffer memory 62 which is composed of active and standby registers. The local CPU writes to the Standby registers and the Hardware Controls write to the Active registers after debouncing, via a Priority controller for bits that can be changed by both hardware and software.

To ensure consistency on all bits in the Standby registers, the transfer to the Active registers is triggered by a write to Byte 1. Therefore, if the content of the Standby registers for Byte 2-4 needs to be changed, they must be written before Byte 1. The content of the Standby registers is transferred to the Active registers on the rising edge of the Clock Enable signal.

After the write to Byte 1, the transfer flag (TSFR) in the Status register will be set to 1 and will be cleared only after the transfer to the Active registers has been completed. Whenever there are no transfer from the Standby to Active registers, the Active registers retain their last value.

Since the Hardware Controls write directly to the Active registers, it is possible that all bits to be set by the Hardware Control will not be changed in the same frame. For example, if a Hardware Control activates one of the comparator bit AND the Card Fail bit, the comparator bit could be set in one frame and the Card Fail in the next, or vice versa, depending on the activation time of the Hardware Control. An advantage of this method is one less frame of Latency.

The content of the Active registers is serialized and a validation code is added. The validation code is an even parity bit for cards using the overhead mode of transmission, and a CRC checksum for cards using dedicated links.

The new Real Time Value will be transmitted in the next frame, and in subsequent frames until the next RTV change. The Seconds counter is adjusted so the trigger occurs in the middle of the frame time, which is well before the transfer from Standby to Active registers.

An exemplary model for the timestamp bus monitoring mechanism is shown in FIG. 11. This function is implemented on all cards connected to the timestamp bus 14. The monitoring mechanism performs two primary tasks: verification code validation and data capture.

With regard to verification code validation, the verification code (CRC-16) is calculated from the data in the current frame. Thus the data must be stored before the CRC can be validated. As the serial data passes through the Verification Code Validation block 70, a CRC-16 computation is executed. The data is converted into bytes and stored in the Memory Current buffer 72. The CRC-16 code received at the end of the valid data is compared against the calculated CRC-16 and if there is no match an error signal is generated. This error signal prevents the content of the Memory Current buffer 72 from being transferred to the Memory Previous buffer 74 and all results from the Byte Comparator block 76 are ignored. The error condition is latched in a Status register until read by the local processor. The CRC-16 code of the standby timestamp bus is also verified and errors are reported. However no data is captured.

With regard to data capture, the data is stored in the Memory Current buffer 72 as it is received. Once the CRC-16 at the end of the block of data as been confirmed valid and the Transfer Inhibit status bit (TSFR INH) is cleared, the content of the Memory Current buffer 72 is transferred to the Memory Previous buffer 74. This coincides with the activation, if any, of the interrupt lines. The Transfer Inhibit status bit is set when the Memory Current buffer 72 is transferred to the Memory Previous buffer 74. It is cleared by writing a 1 to the corresponding bit location in Status Register 78. Thus software has control on when it is ready to receive new data. It is possible to always allow transfers without software intervention by setting the TSFH INH bit in the Mask register. Note that the TSFR INH bit does NOT control the transfer of the RTV value. The local CPU obtains the timestamp bus data from the Memory Previous buffer 74.

Before the data is stored in the Memory Current buffer 72, it is compared against the corresponding previous data stored in the Memory Previous buffer 74. Any difference is captured in Temporary Status Registers. Once all data within a frame has been captured in the Memory Current buffer 72 and the received CRC-16 value has been validated, the Temporary Status Registers are copied to the Status Register 78 and interrupts are generated if required based on the content of the Status Registers. If the received CRC-16 value is invalid, no copying occurs and the Status Registers remain unchanged.

The CRC flag in Status Register 12 is set whenever a frame is received with a bad CRC. The CRC from the standby Timestamp bus is monitored and errors are reported. Changes in this Status Register 78 do not generate IRQ. In normal operation this flag should never be set and a log should be kept if such an event occurs. An A/B flag indicates from which Timestamp bus the data is captured (A=0, B=1).

A 1 in the Status Registers will represent a change in the Timestamp bus data. Unassigned bits default to 0. Once an IRQ has been generated the corresponding bit in Status Register 78 is set, and all bits that are set in the Status Registers remain set until cleared by a CPU read. Until this CPU read, new Timestamp bus data changes set the appropriate bit in the Status Registers. An IRQ is cleared by a write to its corresponding bit in Status Register 78. Note that all bits in Status Register 12 are cleared in the same fashion.

Although the content of the Status Registers are latched until read by the CPU, the actual data contained in the Memory Previous buffer 74 is not, and represents the timestamp bus data in the frame just before the CPU read of the Memory Previous buffer 74.

The timestamp bus data associated with the Real Time Value is treated slightly differently. The value is captured in the Memory Current buffer 72 and transferred to the Memory Previous buffer 74 under the same restriction (except Transfer Inhibit control) as the rest of the data. It is also compared against the value stored in the Memory Previous buffer 74. However only a change in the Real Time Value associated with the timestamp distributor master triggers the interrupt (IRQ 2). This interrupt is cleared as all other bits in Status Register 78.

The Interrupt Mask Registers structure is similar to the Status Register structure. It is thus possible to disable the interrupt generated by a particular timestamp bus time slot and Byte number, but not individual bit in this byte. An Interrupt can be completely disabled through the IRQ Mask register 78.

When the TSFR INH bit is set (1), the transfer of data from Standby to Active registers is always allowed. When set to 0, the transfer is under control of the TSFR INH bit in Status register 78.

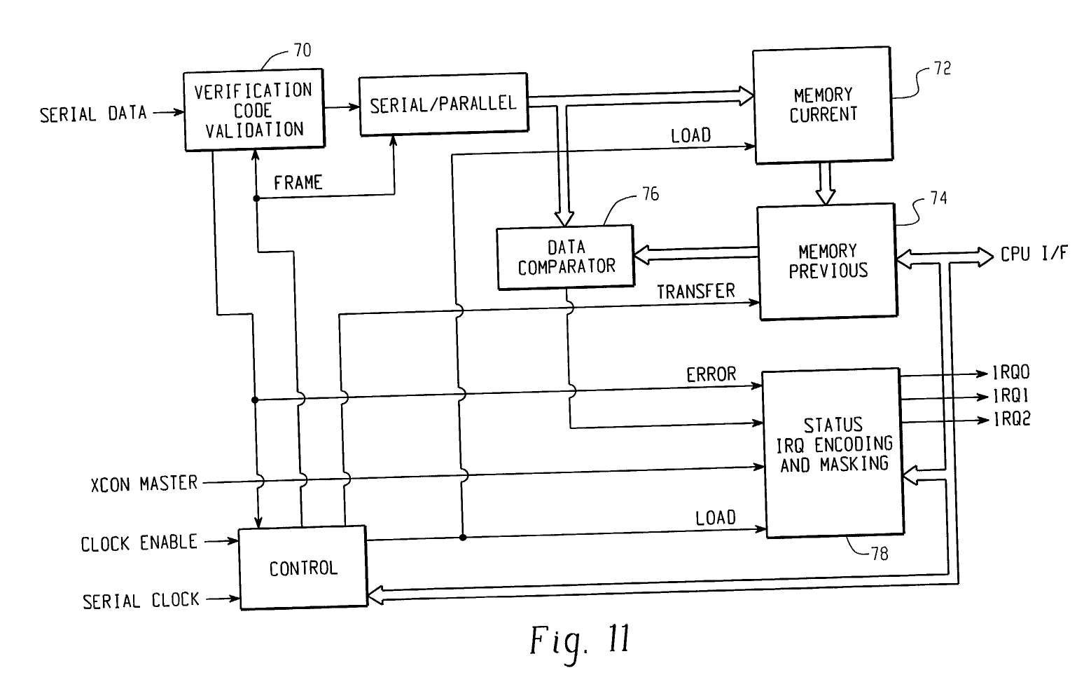

In the embodiment shown in FIG. 12, the processors 10 in the multiprocessor system 2 collect data and transmit them to a primary system processor 28 via dedicated links 60. The timestamp generator 14 generates a timestamp sync signal that it communicates to processors 10 over bus 12. The sync signal is used by the processors 10 to control when they perform their data collection function.

The claimed invention has been described with reference to a particular system for implementing synchronized sampling. It would be obvious, however, to those skilled in the art to apply the invention to other systems without departing from the spirit of the invention. The embodiments described above are examples of structure, systems or methods having elements corresponding to the elements of the invention recited in the claims. This written description may enable those skilled in the art to make and use embodiments having alternative elements that likewise correspond to the elements of the invention recited in the claims. The intended scope of the invention may thus include other structures, systems or methods that do not differ from the literal language of the claims, and may further include other structures, systems or methods with insubstantial differences from the literal language of the claims.

What is claimed is:

1. A multiprocessor system comprising:
a plurality of processor units coupled together via a backplane; and
a timestamp distribution system for providing a first time signal to the plurality of processor units over the backplane, the timestamp distribution system comprising:
a first timestamp distributor for generating the first time signal, and
a first timestamp communication bus on the backplane for transporting the first time signal from the timestamp distributor to the plurality of processor units;
wherein the first time signal comprises a first time data word that is transmitted at a periodic rate and wherein the first time data word does not change each time the first time signal is transmitted.

2. The system according to claim 1 wherein the first time signal further comprises a first data frame having multiple words wherein the first time data word is one of the words in the first data frame.

3. The system according to claim 2 wherein the first data frame further comprises at least one status data word wherein the status data word reports status information regarding at least one of the plurality of processors.

4. The system according to claim 3 wherein the first data frame further comprises at least one status data word for each of the plurality of processors.

5. The system according to claim 1 wherein the first time signal further comprises a clock signal and a clock enable signal.

6. The system according to claim 1 wherein at least one of the plurality of processors performs some action in response to sensing a change in the first time data word.

7. The system according to claim 6 wherein a plurality of the processors perform some action in response to sensing a change in the first time data word.

8. The system according to claim 7 the action performed is a data collection action.

9. The system according to claim 1 wherein the timestamp distribution system further comprises:
a second timestamp distributor for generating a second time signal, and
a second timestamp communication bus on the backplane for transporting the second time signal from the second timestamp distributor to the plurality of processor units;

10. The system according to claim 9 wherein the first time signal further comprises a second time data word that is transmitted at a periodic rate and wherein the second time data word does not change each time the second time data word is transmitted.

11. The system according to claim 9 wherein the first time signal further comprises a first data frame having multiple words wherein the first time data word is one of the words in the first data frame and the second time data word is another word in the first data frame.

12. The system according to claim 11 wherein the first data frame further comprises at least one status data word wherein the status data word reports status information regarding at least one of the plurality of processors.

13. The system according to claim 12 wherein the first data frame further comprises at least one status data word for each of the plurality of processors.

14. The system according to claim 9 wherein at least one of the plurality of processors performs some action in response to sensing a change in the first time data word.

15. The system according to claim 14 wherein a plurality of the processors perform some action in response to sensing a change in the first time data word.

16. The system according to claim 9 wherein the second time signal comprises a second data frame that is transmitted at a periodic rate, the second data frame comprising the first time data word and a second time data word, and wherein the first and second time data words do not change each time the second data frame is transmitted.

17. The system according to claim 16 wherein the second data frame further comprises at least one status data word wherein the status data word reports status information regarding at least one of the plurality of processors.

18. The system according to claim 17 wherein the second data frame further comprises at least one status data word for each of the plurality of processors.

19. The system according to claim 16 wherein at least one of the plurality of processors performs some action in response to sensing a change in the second time data word in the second data frame.

20. The system according to claim 14 wherein a plurality of the processors perform some action in response to sensing a change in the second time data word in the second data frame.

21. The system according to claim 1 further comprising a primary system processor.

22. The system according to claim 21 further comprising a first dedicated link coupling the first timestamp distributor to the primary system processor.

23. The system according to claim 22 wherein the primary system processor is operable to send a real time value to the first timestamp distributor and wherein the first timestamp generator in response to receipt of the real time value resets to a starting state.

24. The system according to claim 21 further comprising a backup system processor.

25. The system according to claim 2 wherein the first timestamp distributor comprises a real time counter for keeping track of time.

26. The system according to claim 25 wherein the first timestamp distributor further comprises a data insertion model for generating the first data frame.

27. The system according to claim 26 wherein the first timestamp distributor further comprises a periodic counter wherein the first time data word is updated in response to a signal from the periodic counter.

28. The system according to claim 1 further comprising a system processor and wherein the plurality of processors collect data in response to sensing a change in the first time data word and transmit the collected data to the system processor.

29. A network node element in a communication network comprising:
a plurality of processor units coupled together via a backplane; and
a timestamp distribution system for providing a first time signal to the plurality of processor units over the backplane, the timestamp distribution system comprising:
a first timestamp distributor for generating the first time signal, and
a first timestamp communication bus on the backplane for transporting the first time signal from the timestamp distributor to the plurality of processor units;
wherein the first time signal comprises a first time data word that is transmitted at a periodic rate and wherein the first time data word does not change each time the first time data word is transmitted.

30. The node element according to claim 29 wherein the first time signal further comprises a first data frame having multiple words wherein the first time data word is one of the words in the first data frame.

31. The node element according to claim 30 wherein the first data frame further comprises at least one status data word wherein the status data word reports status information regarding at least one of the plurality of processors.

32. The node element according to claim 31 wherein the first data frame further comprises at least one status data word for each of the plurality of processors.

33. The node element according to claim 29 wherein the first time signal further comprises a clock signal and a clock enable signal.

34. The node element according to claim 29 wherein at least one of the plurality of processors performs some action in response to sensing a change in the first time data word.

35. The node element according to claim 35 wherein a plurality of the processors perform some action in response to sensing a change in the first time data word.

36. A timestamp distribution system for a backplane system having a plurality of processors, the timestamp distribution system comprising:
a first timestamp distributor for generating a first time signal, and
a first timestamp communication bus on the backplane for transporting the first time signal from the timestamp distributor to the plurality of processor units;
the first time signal comprising a first data frame that is transmitted at a periodic rate, the first data frame comprising a first time data word wherein the first time data word does not change each time the first data frame is transmitted;
the first data frame further comprising at least one status data word wherein the status data word reports status information regarding at least one of the plurality of processors.

37. The timestamp distribution system according to claim 36 wherein the first data frame further comprises at least one status data word for each of the plurality of processors.

38. The timestamp distribution system to claim 36 wherein the first time signal further comprises a clock signal and a clock enable signal.

39. A method for performing synchronized operations in a multiprocessor system comprising the steps of:
providing a timestamp distributor system comprising a first timestamp distributor for generating a first time signal and a first timestamp communication bus on a backplane for transporting the first time signal from the timestamp distributor to the plurality of processor units in the multiprocessor system;
generating the first time signal with the first timestamp generator, wherein the first time signal comprises a first data frame having a first time data word;
transmitting the first data frame at a periodic rate;
signaling a plurality of the processor units to perform some action by changing the first time data word, wherein the first time data word is not changed each time the first data frame is transmitted.
